(19) United States
(12) Patent Application Publication
(10) Pub. No.: US 2021/0101288 A1
(43) Pub. Date: Apr. 8, 2021

(54) MOVING BED ROBOT

(71) Applicant: LG ELECTRONICS INC., Seoul (KR)

(72) Inventor: Sangwook LEE, Seoul (KR)

(73) Assignee: LG ELECTRONICS INC., Seoul (KR)

(21) Appl. No.: 16/845,584

(22) Filed: Apr. 10, 2020

(30) Foreign Application Priority Data
Oct. 8, 2019 (KR) 10-2019-0124253

(51) Int. Cl. B25J 11/00; B25J 5/00; A61G 7/05; A61G 7/012

(52) U.S. Cl. CPC B25J 11/009; B25J 5/007; A61G 2203/22; A61G 7/012; A61G 7/05

(57) ABSTRACT

A moving bed robot includes an upper plate, a lower plate disposed below the upper plate, a supporter protruding downward from the upper plate and coming in contact with the lower plate to support the upper plate, a plurality of load cells disposed between the upper plate and the lower plate to detect a lateral force, a fixing portion protruding or bent upward from the lower plate and coupled to the load cell, a protrusion portion protruding downward from the upper plate and disposed at an opposite side of the fixing portion with respect to the load cell to apply a force to the load cell, a frame connected to the lower plate and provided with a caster, a driving wheel connected to the frame, a driving motor configured to rotate the driving wheel, and a controller configured to receive an electrical signal of the load cell and control the driving motor.

### CROSS-REFERENCE TO RELATED APPLICATIONS

The present application claims priority under 35 U.S.C. 119 to Korean Patent Application No. 10-2019-0124253 filed on Oct. 8, 2019, which is hereby incorporated by reference in its entirety.

### BACKGROUND

The present disclosure relates to a moving bed robot.

In general, a moving bed is used as a device for transporting a patient in need of surgery to an operating room, transporting a patient to a hospital room after surgery, or safely transporting an unconscious or emergency patient.

An assistant can move the moving bed by pulling the moving bed from in front, pushing the moving bed from behind, or pushing or pulling the moving bed from the side.

However, there is a problem in that the physical energy expelled by the assistant is large when repeatedly move the moving bed while bearing the weight of the patient. In addition, there is a problem that it is difficult to change the direction of the moving bed while bearing the weight of the patient.

### SUMMARY

An aspect of the present disclosure is to provide a moving bed robot capable of being easily moved even with a small force.

Another aspect of the present disclosure is to provide a moving bed robot capable of being intuitively used by an operator.

In one embodiment, a moving bed robot may include: an upper plate; a lower plate disposed below the upper plate; a supporter protruding downward from the upper plate and coming in contact with the lower plate to support the upper plate; a plurality of load cells disposed between the upper plate and the lower plate to detect a lateral force; a fixing portion protruding or bent upward from the lower plate and coupled to the load cell; a protrusion portion protruding downward from the upper plate and disposed at an opposite side of the fixing portion with respect to the load cell to apply a force to the load cell; a frame connected to the lower plate and provided with a caster; a driving wheel connected to the frame; a driving motor configured to rotate the driving wheel; and a controller configured to receive an electrical signal of the load cell and control the driving motor.

The plurality of load cells may include: a first load cell configured to detect a force acting in a front-and-rear direction; and a second load cell configured to detect a force acting in a left-and-right direction.

The first load cell may be disposed at a central portion of the lower plate with respect to the left-and-right direction, and the second load cell may be disposed at a central portion of the lower plate with respect to the front-and-rear direction.

The fixing portion may be formed at an edge of the lower plate.

The first load cell may include: a front load cell adjacent to a front edge of the lower plate; and a rear load cell adjacent to a rear edge of the lower plate.

The second load cell may include: a left load cell adjacent to a left edge of the lower plate; and a right load cell adjacent to a right edge of the lower plate.

The supporter may include a contact portion being in contact with the lower plate, and the contact portion may have a smaller cross-sectional area toward a lower side.

The fixing portion may be spaced apart from the upper plate in a vertical direction, and the protrusion portion may be spaced apart from the lower plate in the vertical direction.

The driving wheel may be provided with a pair of driving wheels having rotational shafts disposed on a straight line, and the driving motor may be provided with a pair of driving motors configured to independently rotate the pair of driving wheel.

The moving bed robot may further include: a fixing bracket fixed to the frame; a moving bracket connected to the fixing bracket and the driving wheel; and a rotary motor configured to rotate the moving bracket with respect to the fixing bracket.

The moving bed robot may further include a contact sensor configured to detect whether the driving wheel comes in contact with a floor surface.

The controller may be configured to: electrically communicate with the contact sensor to control the rotary motor such that the driving wheel maintains the contact with the floor surface; or control the rotary motor such that the driving wheel is spaced apart from the floor surface.

The load cell may be coupled to the protrusion portion, and the upper plate may be movable within a deformation range of the load cell with respect to the lower plate.

The frame may include: a base frame provided with the caster and a driving wheel; a pair of support beams coupled to both sides of the lower plate and formed to be long in a front-and-rear direction; and a connecting frame configured to connect the pair of support beams to the base frame.

The base frame may include: a pair of base beams formed to be long in the front-and-rear direction, connected to the caster, and spaced apart in parallel in a left-and-right direction; and a connecting beam formed to be long in the left-and-right direction to connect the pair of base beams, and connected to the driving wheel.

The base frame may include: a front base bar configured to connect the pair of base beams, and disposed in front of the connecting beam; a rear base bar configured to connect the pair of base beams, and disposed in rear of the connecting beam; a pair of front supports formed to be inclined vertically or upwardly on the front base bar; and a pair of rear supports formed to be inclined vertically or upwardly on the rear base bar.

The connecting frame may include: a pair of front frames coupled to front portions of the pair of support beams, respectively; a pair of rear frames coupled to rear portions of the pair of support beams, respectively; a front connecting bar configured to connect the pair of front frames, formed to be long in the left-and-right direction, and disposed below the lower plate; a rear connecting bar configured to connect the pair of rear frames, formed to be long in the left-and-right direction, and disposed below the lower plate; a pair of front links rotatably connected to the pair of front supports and the pair of front frames; and a pair of rear links rotatably connected to the pair of rear supports and the pair of rear frames.

The connecting frame may further include: a front link bar configured to connect the pair of front links; and a rear link bar configured to connect the pair of rear links.

The moving bed robot may further include: an actuator connected to the rear connecting bar to move a piston in the front-and-rear direction; and a connecting rod connected to the piston to move in the front-and-rear direction and rotatably connected to a lever formed in the front link bar.

In one embodiment, a moving bed robot may include: an upper plate; a support beam disposed below the upper plate; a rail provided in the support beam; a slider configured to slide along the rail; a handle connected to the slider to slide together with the slider; a fixing portion connected to a lower side of the support beam and facing the handle in a longitudinal direction of the rail; a load cell disposed between the fixing portion and the handle; a base frame provided with a caster; a connecting frame configured to connect the support beam to the base frame; a driving wheel connected to the base frame; a driving motor configured to rotate the driving wheel; and a controller configured to receive an electrical signal of the load cell and control the driving motor.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates an AI device including a robot according to an embodiment.

FIG. 2 illustrates an AI server connected to a robot according to an embodiment.

FIG. 3 illustrates an AI system according to an embodiment.

FIG. 4 is a perspective view of a moving bed robot according to an embodiment.

FIG. 5 is a side view of the moving bed robot according to the embodiment.

FIG. 6 is an exploded perspective view of the moving bed robot according to the embodiment.

FIG. 7 is a perspective view illustrating a state in which an upper plate, a lower plate, and a support beam are removed from the moving bed robot according to the embodiment.

FIG. 8 is a perspective view illustrating a state in which the upper plate, the lower plate, and the support beam are removed from the moving bed robot according to the embodiment, when viewed in another direction.

FIG. 9 is a view illustrating the bottom surface of the upper plate according to an embodiment.

FIG. 10 is a view illustrating a lower plate and a load cell seated thereon according to an embodiment.

FIG. 11 is a cross-sectional view taken along line A-A′ of FIG. 4.

FIG. 12 is an enlarged view illustrating a driving wheel module and the surroundings thereof according to an embodiment.

FIG. 13 is a control block diagram of the moving bed robot according to an embodiment.

FIG. 14 is a perspective view of a moving bed robot according to another embodiment.

FIG. 15 is a cross-sectional view for describing a structure of a handle illustrated in FIG. 14.

### DETAILED DESCRIPTION OF THE EMBODIMENTS

With respect to constituent elements used in the following description, suffixes “module” and “interface” are given only in consideration of ease in the preparation of the specification, and do not have or serve as different meanings. Accordingly, the suffixes “module” and “interface” may be used interchangeably.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot may include a driver having an actuator or a motor which may perform various physical operations such as moving a robot joint. In addition, a movable robot may include a wheel, a brake, a propeller, or the like in a driver, and may travel on the ground or fly in the air via the driver.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

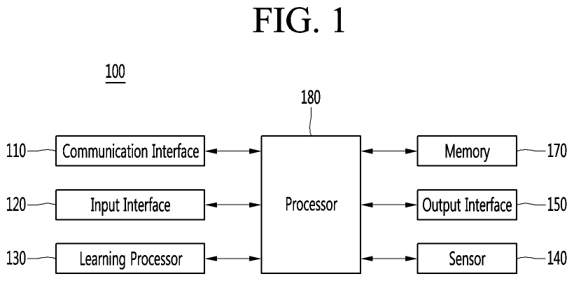

FIG. 1 illustrates an AI device 100 including a robot according to an embodiment.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensor 140, an output interface 150, a memory 170, and a processor 180.

The communication interface 110 may transmit and receive data to and from external devices such as other AI devices 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform Al processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the Al device 100, or a memory held in an external device.

The sensor 140 may acquire at least one of internal information about the AI device 100, ambient environment information about the AI device 100, and user information by using various sensors.

Examples of the sensors included in the sensor 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the Al server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

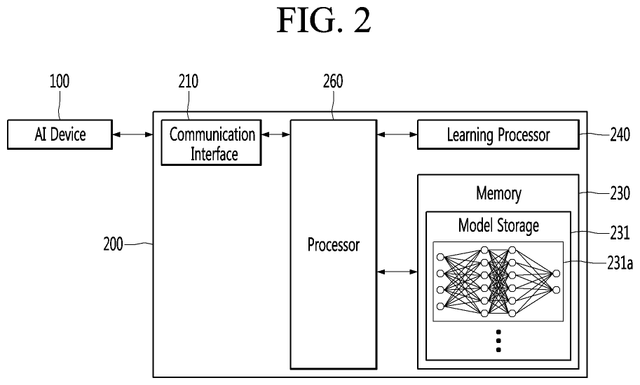

FIG. 2 illustrates an AI server 200 connected to a robot according to an embodiment.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 210, a memory 230, a learning processor 240, a processor 260, and the like.

The communication interface 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

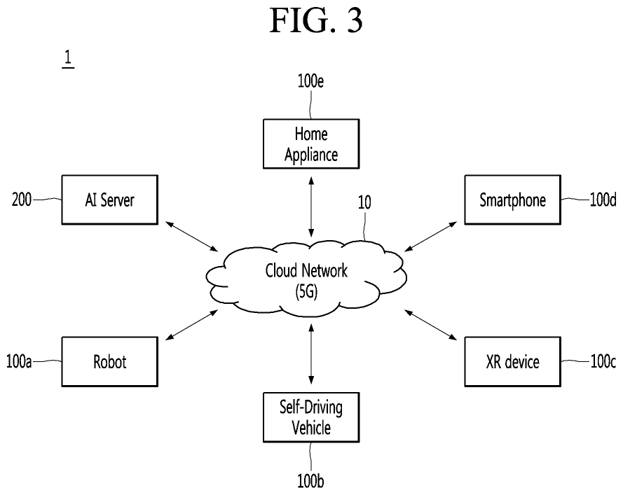

FIG. 3 illustrates an AI system 1 according to an embodiment.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and AI server 200 defining the AI system 1 may be connected to each other through the cloud network 10. In particular, each of the devices 100a to 100e and 200 may communicate with each other through a base station, but may directly communicate with each other without using a base station.

The AI server 200 may include a server that performs Al processing and a server that performs operations on big data.

The AI server 200 may be connected to at least one of the AI devices constituting the Al system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driver such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driver based on the control/interaction of the user. At this time, the robot 100a may acquire the intention information of the interaction due to the user's operation or speech utterance, and may determine the response based on the acquired intention information, and may perform the operation.

<AI+Robot+Self-Driving>

The robot 100a, to which the Al technology and the self-driving technology are applied, may be implemented as a guide robot, a carrying robot, a cleaning robot, a wearable robot, an entertainment robot, a pet robot, an unmanned flying robot, or the like.

The robot 100a, to which the Al technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driver of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

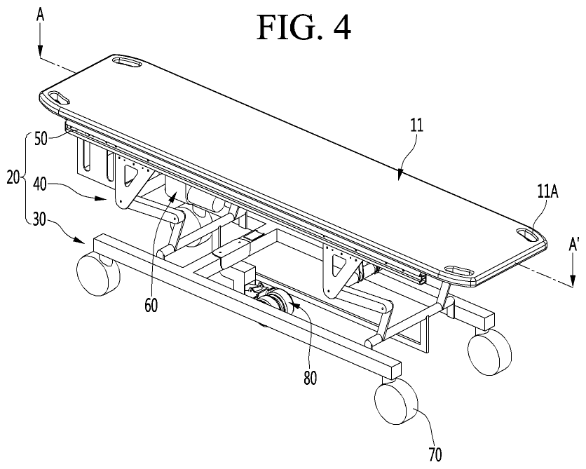

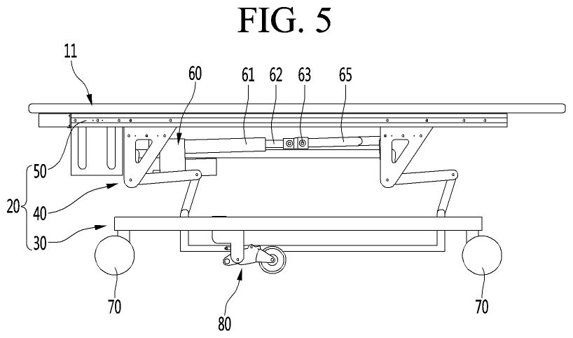

FIG. 4 is a perspective view of a moving bed robot according to an embodiment, and FIG. 5 is a side view of the moving bed robot according to the embodiment.

The moving bed robot according to the present embodiment may be the robot 100a having the self-driving function described above. The moving bed robot may be a moving bed.

The moving bed robot according to the present embodiment may include an upper plate 11, a frame 20, and a driving wheel module 80. The moving bed robot according to the present embodiment may further include an actuator 60.

The upper plate 11 may be horizontally disposed. The upper plate 11 may support, from a lower side, a mattress or bedding for the patient to lie down.

The upper plate 11 may have a substantially rectangular shape. A long side of the upper plate 11 may be formed to extend with respect to a first direction, and a short side may be formed to extend with respect to a second direction perpendicular to the first direction. Hereinafter, it is assumed that the first direction is a front-and-rear direction and the second direction is a left-and-right direction.

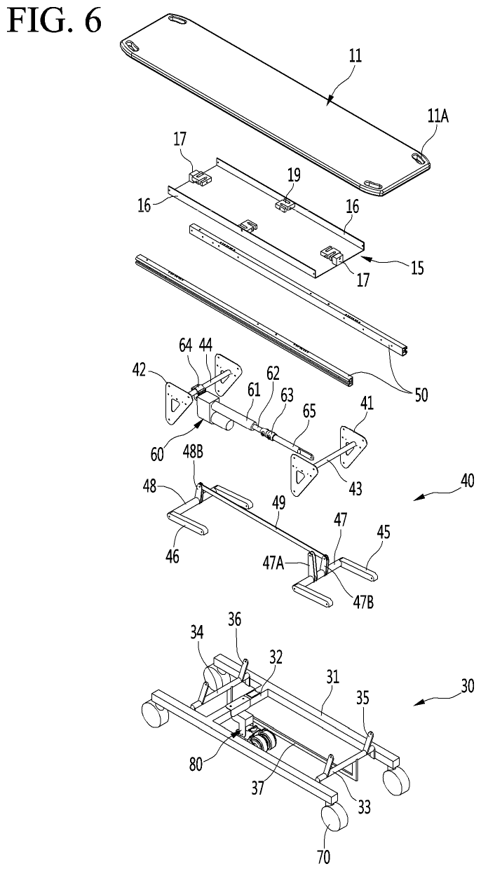

At least one grip hole 11A may be formed in the upper plate 11. Preferably, a plurality of grip holes 11A may be formed. The grip hole 11A may be formed to penetrate the upper plate 11 in a vertical direction. The grip hole 11A may be formed adjacent to a front side edge and/or a rear side edge of the upper plate 11. The grip hole 11A may be located so as to not overlap a lower plate 15 (see FIG. 6) of the moving be robot in a vertical direction.

An operator may insert his or her hand into the grip hole 11A and easily push or pull the upper plate 11.

The frame 20 may support the upper plate 11 and the lower plate 15 (see FIG. 6). In more detail, the lower plate 15 may be coupled to an upper portion of the frame 20, and the lower plate 15 may support the upper plate 11. The frame 20 may be disposed below the upper plate 11. That is, the frame 20 may be spaced apart from the upper plate 11, without coming in contact with the upper plate 11.

The frame 20 may be provided with a caster 70. Therefore, the operator may easily move the moving bed robot.

The caster 70 may come in contact with the floor surface. The caster 70 may support the total load of the moving bed robot. The caster 70 is preferably provided as a plurality of casters spaced apart from each other. For example, the plurality of casters may include a pair of front casters and a pair of rear casters.

The frame 20 may include a base frame 30, a connecting frame 40, and a support beam 50.

The base frame 30 may be spaced apart from and below the upper plate 11.

The base frame 30 may be provided with the caster 70. The base frame 30 may be equipped with a driving wheel module 80, which is described below.

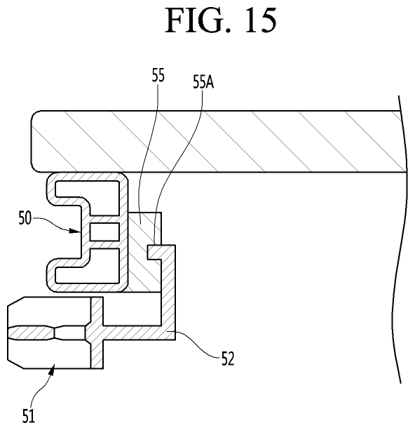

The support beam 50 may be provided as a pair of support beams spaced apart in parallel in a left-and-right direction. The support beam 50 may be formed to extend in a front-and-rear direction. The support beam 50 may be coupled to the lower plate 15 (see FIGS. 6 and 15).

The support beam 50 may be disposed below the upper plate 11. In more detail, the support beam 50 may be disposed below both edges of the upper plate 11. A predetermined gap may be formed between the support beam 50 and the upper plate 11.

The connecting frame 40 may couple the base frame 30 to the support beam 50. The connecting frame 40 may be coupled to the support beam 50 and/or the lower plate 15.

The height of the connecting frame 40 may be adjusted by the actuator 60.

The driving wheel module 80 may drive the movement of the moving bed robot, or may assist in the movement of the moving bed robot. The driving wheel module 80 may be mounted on the frame 20, more specifically, the base frame 30. The configuration and operation of the driving wheel module 80 will be described below.

The actuator 60 may be mounted on the connecting frame 40. The actuator 60 may adjust the height of the connecting frame 40.

The actuator 60 may include a cylinder 61 and a piston 62 moveable relative to the cylinder 61. The cylinder 61 may be disposed to extend in the approximately front-and-rear directions, and the piston 62 may move in the longitudinal direction of the cylinder 61, that is, in the front-and-rear direction. The piston 62 may be connected to a connecting rod 65 by a connector 63. The detailed operation of the actuator 60 will be described below in detail.

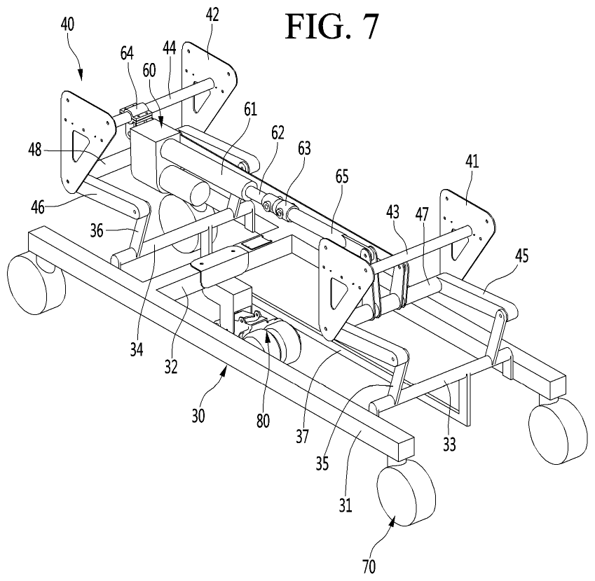

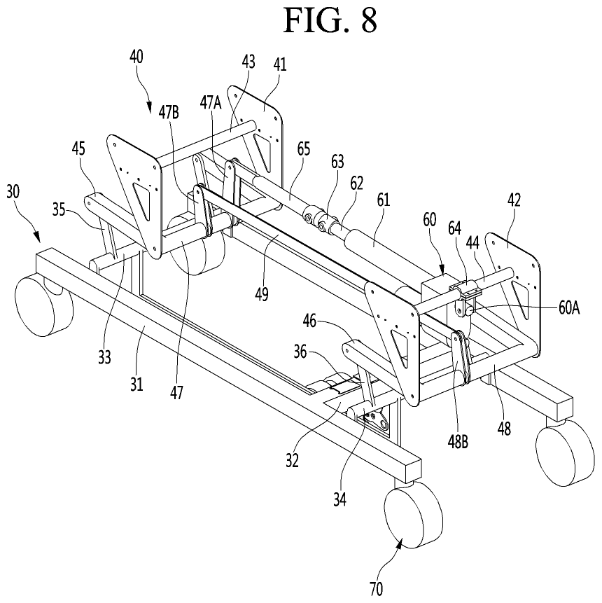

FIG. 6 is an exploded perspective view of the moving bed robot according to the embodiment, FIG. 7 is a perspective view illustrating a state in which the upper plate, the lower plate, and the support beam are removed from the moving bed robot according to the embodiment, and FIG. 8 is a perspective view illustrating a state in which the upper plate, the lower plate, and the support beam are removed from the moving bed robot according to the embodiment, when viewed in another direction.

The moving bed robot according to the present embodiment may include a lower plate 15 and a load cell 19.

The lower plate 15 may be disposed horizontally below the upper plate 11. The lower plate 15 may have a substantially rectangular shape.

The size of the lower plate 15 may be smaller than the size of the upper plate 11. In more detail, the length of the lower plate 15 may be shorter than the length of the upper plate 11 with respect to the front-and-rear direction. In addition, the width of the lower plate 15 may be smaller than the width of the upper plate 11 with respect to the left-and-right direction.

The lower plate 15 may be coupled to the upper portion of the frame 20. In more detail, the lower plate 15 may be coupled to the support beam 50. In more detail, the lower plate 15 may include a bent portion 16 bent upward from both edges of the lower plate 15, and the bent portion 16 may be coupled to the support beam 50. The bent portion 16 may be spaced apart from the upper plate 11 in the vertical direction.

In addition, the lower plate 15 may be provided with a protrusion portion 17 protruding upward from the lower plate 15. The protrusion portion 17 may be adjacent to the front and rear edges of the lower plate 15. The protrusion portion 17 may be spaced apart from the upper plate 11 in the vertical direction.

The load cell 19 may be coupled to the bent portion 16 and the protrusion portion 17.

The load cell 19 may be disposed between the upper plate 11 and the lower plate 15. Preferably, the load cell 19 may be spaced apart downward from the upper plate 11, may be spaced apart upward from the lower plate 15. The load cell 19 may detect a lateral force.

The load cell 19 may be provided as a plurality of load cells. Some of the plurality of load cells 19 may detect a force in the front-and-rear direction, and others may detect a force in the left-and-right direction. Since the operation principle of the load cell 19 is well known, detailed description thereof will be omitted.

When the upper plate 11 moves in the horizontal direction with respect to the lower plate 15, the load cell 19 may detect the movement of the upper plate, and the driving wheel module 80 may be driven according to the detection result of the load cell 19.

Meanwhile, the base frame 30 may include a pair of base beams 31 spaced apart in parallel in the left-and-right direction and a connecting beam 32 configured to couple the pair of base beams 31. The pair of base beams 31 and the connecting beam 32 may be integrally formed.

The base beam 31 may be formed to extend in the front-and-rear direction. The cross section of the base beam 31 may be rectangular. The casters 70 may be provided at opposite ends of the base beam 31. In more detail, the casters 70 may be connected to bottom surfaces of the opposite ends of the base beam 31.

The connecting beam 32 may be formed to extend in the left-and-right direction. The cross section of the connecting beam 32 may be rectangular. Opposite ends of the connecting beam 32 may be connected to the pair of base beams 31, respectively.

The connecting beam 32 may be connected to the rear portion of the base beam 31. In more detail, the front-and-rear distance between the rear end of the base beam 31 and the connecting beam 32 may be shorter than the front-and-rear distance between the front end of the base beam 31 and the connecting beam 32.

The driving wheel module 80 may be installed in the connecting beam 32.

The base frame 30 may further include a front base bar 33, a rear base bar 34, a front support 35, and a rear support 36.

The front base bar 33 and the rear base bar 34 may be formed to extend in the left-and-right direction. That is, the front base bar 33 and the rear base bar 34 may be parallel with the connecting beam 32. The cross sections of the front base bar 33 and the rear base bar 34 may be circular. Opposite ends of the front base bar 33 and the rear base bar 34 may be connected to the pair of base beams 31, respectively.

The front base bar 33 may be connected to the front portion of the base beam 31, and the rear base bar 34 may be connected to the rear portion of the base beam 31. The front base bar 33 may be disposed in front of the connecting beam 32, and the rear base bar 34 may be disposed behind the connecting beam 32.

In more detail, with respect to the rear end of the base beam 31, the front-and-rear distance to the connecting beam 32 may be closer than the front-and-rear distance to the front base bar 33 and farther than the front-and-rear distance to the rear base bar 34.

In addition, the front-and-rear distance between the connecting beam 32 and the front base bar 33 may be farther than the front-and-rear distance between the connecting beam 32 and the rear base bar 34. That is, the connecting beam 32 may be closer to the rear base bar 34 than the front base bar 33.

The front support 35 may be formed to be inclined vertically or upwardly from the front base bar 33. Preferably, the front support 35 may be formed in the front base bar 33 to be inclined in a direction in which the height increases toward the front side. The front support 35 may be provided as a pair of front supports spaced apart in parallel in the left-and-right direction.

The rear support 36 may be formed to be inclined vertically or upwardly from the rear base bar 34. Preferably, the rear support 36 may be formed in the rear base bar 34 to be inclined in a direction in which the height increases toward the front side. The rear support 36 may be provided as a pair of rear supports spaced apart in parallel in the left-and-right direction.

The base frame 30 may further include a reinforcement frame 37 configured to couple the front base bar 33 to the rear base bar 34.

In more detail, the reinforcement frame 37 may include a horizontal portion and a pair of vertical portions extending upward from opposite ends of the horizontal portion. The horizontal portion may pass below the connecting beam 32. In addition, the horizontal portion may pass along a side of the driving wheel module 80. One of the pair of vertical portions may be connected to the lower side of the front base bar 33 and the other of the pair of vertical portions thereof may be connected to the lower side of the rear base bar 34.

The connecting portion of the reinforcement frame 37 and the front base bar 33 may be disposed between the pair of front supports 35 with respect to the left-and-right direction. The connecting portion of the reinforcement frame 37 and the rear base bar 34 may be disposed between the pair of rear supports 36 with respect to the left-and-right direction.

Meanwhile, the support beam 50 may be coupled to the lower plate 15. In more detail, the support beam 50 may be coupled to the bent portion 16. For example, the support beam 50 may be coupled to the outside of the bent portion 16.

The support beam 50 may support the upper plate 11 and the lower plate 15. In more detail, the lower plate 15 may be coupled to the support beam 50, and the lower plate 15 may support the upper plate 11.

Meanwhile, the connecting frame 40 may include a front frame 41, a rear frame 42, a front connecting bar 43, a rear connecting bar 44, a front link 45, and a rear link 46. The connecting frame 40 may further include a front link bar 47 and a rear link bar 48.

The front frame 41 may be provided as a pair of front frames spaced apart in parallel in the left-and-right direction. The front frame 41 may have a panel shape having a predetermined thickness in the left-and-right direction. The front frame 41 may be vertically disposed.

The front frame 41 may be coupled to the lower plate 15, more specifically, the bent portion 16. A part of the upper portion of the front frame 41 may be disposed between the bent portion 16 and the support beam 50, and may be coupled to the bent portion 16 and the support beam 50.

The lower portion of the front frame 41 may be rotatably connected to the front link 45, which will be described below. The front frame 41 and the front link 45 may rotate with respect to a rotational axis extending in the left-and-right direction.

The front connecting bar 43 may couple the pair of front frames 41. The front connecting bar 43 may be formed to extend in the left-and-right direction. The front connecting bar 43 may be horizontal. The front connecting bar 43 may be disposed below the lower plate 15 and the support beam 50.

The rear frame 42 may be provided as a pair of rear frames spaced apart in parallel in the left-and-right direction. The rear frame 42 may have a panel shape having a predetermined thickness in the left-and-right direction. The rear frame 42 may be vertically disposed.

The rear frame 42 may be disposed behind the front frame 41.

The rear frame 42 may be coupled to the lower plate 15, more specifically, to the bent portion 16. A part of the upper portion of the rear frame 42 may be disposed between the bent portion 16 and the support beam 50, and may be coupled to the bent portion 16 and the support beam 50.

The lower portion of the rear frame 42 may be rotatably connected to the rear link 46, which will be described below. The rear frame 42 and the rear link 46 may rotate with respect to a rotational axis extending in the left-and-right direction.

The rear connecting bar 44 may couple the pair of rear frames 42. The rear connecting bar 44 may be formed to extend in the left-and-right direction. The rear connecting bar 44 may be horizontal. The rear connecting bar 44 may be disposed below the lower plate 15 and the support beam 50. The rear connecting bar 44 may be disposed behind the front connecting bar 43.

Meanwhile, the front link 45 may couple the front support 35 to the front frame 41. The front link 45 may be formed to extend in the front-and-rear direction. The front link 45 may be provided as a pair of front links spaced apart in parallel in the left-and-right direction.

The front link 45 may be rotatably connected to each of the front support 35 and the front frame 41. The front link 45 and the front support 35 may rotate with respect to a rotational axis extending in the left-and-right direction. The front link 45 and the front frame 41 may rotate with respect to the rotational axis extending in the left-and-right direction.

In more detail, the front end of the front link 45 may be rotatably connected to the upper end of the front support 35. The rear end of the front link 45 may be rotatably connected to the lower portion of the front frame 41.

The front link bar 47 may couple the pair of front links 45. The front link bar 47 may rotate together with the front link 45.

The front link bar 47 may be provided with a front connecting lever 47B to which a coupler 49, which will be described below, is connected. The front connecting lever 47B may be formed to be inclined vertically or upwardly from the front link bar 47.

The rear link 46 may couple the rear support 36 to the rear frame 42. The rear link 46 may be formed to extend in the front-and-rear direction. The rear link 46 may be provided as a pair of rear links spaced apart in parallel in the left-and-right direction.

The rear link 46 may be disposed behind the front link 45.

The rear link 46 may be rotatably connected to each of the rear support 36 and the rear frame 42. The rear link 46 and the rear support 36 may rotate with respect to a rotational axis extending in the left-and-right direction. The rear link 46 and the rear frame 42 may rotate with respect to the rotational axis extending in the left-and-right direction.

In more detail, the front end of the rear link 46 may be rotatably connected to the upper end of the rear support 36. The rear end of the rear link 46 may be rotatably connected to the lower portion of the rear frame 42.

The rear link bar 48 may couple the pair of rear links 46. The rear link bar 48 may rotate together with the rear link 46.

The rear link bar 48 may be disposed behind the front link bar 47.

The rear link bar 48 may be provided with a rear connecting lever 48B to which a coupler 49, which will be described below, is connected. The rear connecting lever 48B may be formed to be inclined vertically or upwardly to the rear link bar 48.

The connecting frame 40 may further include a coupler 49. The coupler 49 may be formed to extend in the front-and-rear direction. The coupler 49 may have a predetermined thickness in the horizontal direction. The coupler 49 may interwork with the rotation of the front link bar 47 and the rear link bar 48.

In more detail, the coupler 49 may couple the front connecting lever 47B to the rear connecting lever 48B. The coupler 49 may be rotatably connected to the front connecting lever 47B and the rear connecting lever 48B. The coupler 49 and the front connecting lever 47B may rotate with respect to the rotational axis extending in the left-and-right direction. The coupler 49 and the rear connecting lever 48B can rotate with respect to the rotational axis extending in the left-and-right direction.

The front end of the coupler 49 may be rotatably connected to the upper end of the front connecting lever 47B, and the rear end of the coupler 49 may be rotatably connected to the upper end of the rear connecting lever 48B.

Meanwhile, the actuator 60 may be mounted on one of the front connecting bar 43 and the rear connecting bar 44. In addition, a power transmission lever 47A to which the power of the actuator 60 is transmitted may be formed on one of the front link bar 47 and the rear link bar 48.

When the actuator 60 is connected to the front connecting bar 43, the power transmission lever 47A may be formed in the rear link bar 48. Meanwhile, when the actuator 60 is connected to the rear connecting bar 44, the power transmission lever 47A may be formed in the front link bar 47. Hereinafter, a case where the actuator 60 is connected to the rear connecting bar 44 and the power transmission lever 47A is formed in the front link bar 47 will be described as an example.

The actuator 60 may be connected to the rear connecting bar 44. In more detail, the bracket 64 to which the actuator 60 is connected may be mounted on the rear connecting bar 44.

The bracket 64 may be coupled by wrapping the circumference of the rear connecting bar 44. The actuator 60 may be rotatably connected to the connecting bar 44 via the bracket 64. In more detail, the actuator 60 may include a bracket connecting portion 60A rotatably connected to the bracket 64. The bracket connecting portion 60A may protrude rearward from the actuator 60. The bracket connecting portion 60A and the bracket 64 may rotate with respect to the rotational axis extending in the left-and-right direction.

As described above, the actuator 60 may include the cylinder 61 and the piston 62. The cylinder 61 may be formed to extend in the front-and-rear direction. The piston 62 may be moved in the longitudinal direction, that is, the front-and-rear direction of the cylinder 61 in a state where a part of the piston 62 is inserted into the cylinder 61.

The piston 62 may be connected to the connecting rod 65 by the connector 63. The connecting rod 65 may extend in the longitudinal direction of the piston 62 and the cylinder 61.

The connecting rod 65 may be rotatably connected to the power transmission lever 47A formed in the front link bar 47. Therefore, the power of the actuator 60 may be transmitted to the power transmission lever 47A.

The power transmission lever 47A may be formed in the front link bar 47. The power transmission lever 47A may be formed to be inclined vertically or upwardly to the front link bar 47. Preferably, the power transmission lever 47A may be formed to be inclined in a direction in which the height increases toward the rear side. The power transmission lever 47A may be spaced apart from the front connecting lever 47B in the left-and-right direction.

The power transmission lever 47A, the front connecting lever 47B, the front link bar 47, and the front link 45 may rotate together. The rear connecting lever 48B, the rear link bar 48, and the rear link 46 may rotate together.

Therefore, when the connecting rod 65 moves forward or backward, the power transmission lever 47A, the front link bar 47 and the front link 45, and the front connecting lever 47B may rotate together. In addition, since the front connecting lever 47B and the rear connecting lever 48B are connected by the coupler 49, the rear connecting lever 48B, the rear link bar 48, and the rear link 46 may rotate together.

Meanwhile, the front support 35 connected to the front link 45 may be fixed to the front base bar 33 and may not rotate. In addition, the front frame 41 connected to the front link 45 may be coupled to the lower plate 15 and/or the support beam 50 and may not rotate. In addition, the rear support 36 connected to the rear link 46 may be fixed to the rear base bar 34 and may not rotate. In addition, the rear frame 42 connected to the rear link 46 may be coupled to the lower plate 15 and/or the support beam 50 and may not rotate.

Therefore, when the actuator 60 pushes the connecting rod 65, the front frame 41, the rear frame 42, the support beam 50, the lower plate 15, and the upper plate 11 may move upward without rotation. That is, the height of the moving bed robot may be increased.

On the contrary, when the actuator 60 pulls the connecting rod 65, the front frame 41, the rear frame 42, the support beam 50, the lower plate 15, and the upper plate 11 may move downward without rotation. That is, the height of the moving bed robot may be decreased.

Therefore, the height of the moving bed robot may be easily adjusted by the actuator 60.

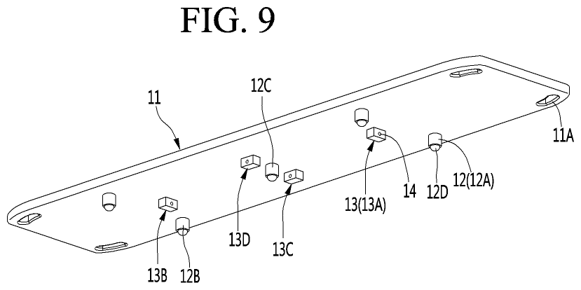

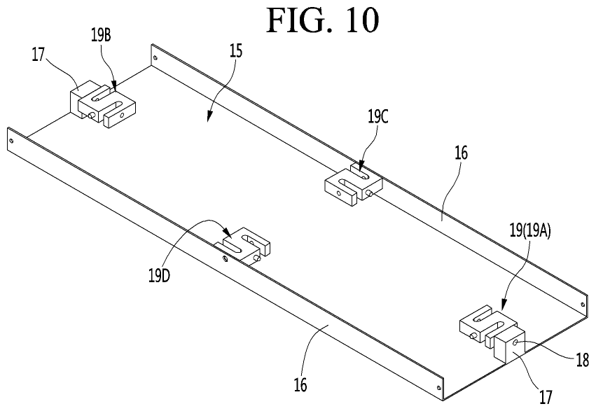

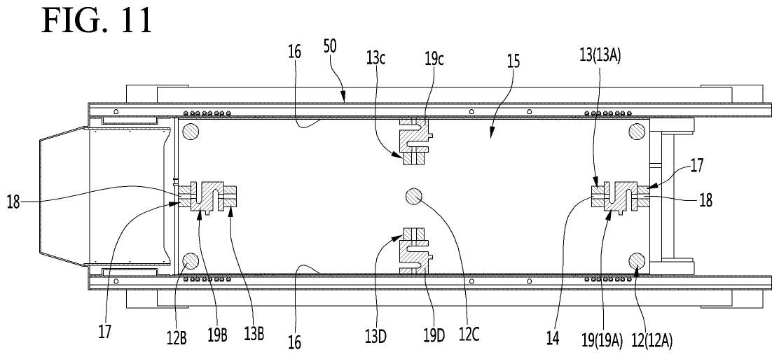

FIG. 9 is a view illustrating the bottom surface of the upper plate according to an embodiment, FIG. 10 is a view illustrating the lower plate and the load cell seated thereon according to an embodiment, and FIG. 11 is a cross-sectional view taken along line A-A′ of FIG. 4.

A plurality of supporters 12 may be formed on the upper plate 11. The plurality of supporters 12 may protrude toward the lower plate 15 from the bottom surface of the upper plate 11. The plurality of supporters 12 may come in contact with the lower plate 15. The plurality of supporters 12 may support the upper plate 11 on the lower plate 15, and may space the upper plate 11 apart from the lower plate 15.

The plurality of supporters 12 may be spaced apart from each other. The plurality of supporters 12 may be evenly arranged such that the upper plate 11 is horizontally maintained without being inclined.

For example, the plurality of supporters 12 may include a pair of front supporters 12A in contact with a portion adjacent to the front edge of the upper surface of the lower plate 15, a pair of rear supporters 12B in contact with a portion adjacent to the rear edge of the upper surface of the lower plate 15, and a center supporter 12C in contact with the central portion of the upper surface of the lower plate 15.

Each of the supporters 12 may include a contact portion 12D. The contact portion 12D may be in contact with the upper surface of the lower plate 15. The contact portion 12D may have a smaller cross-sectional area toward the lower side. The contact portion 12D may include a part of a spherical surface. The contact portion 12D is preferably in point contact with the lower plate 15.

Therefore, the contact area between the supporter 12 and the lower plate 15 may be minimized. Therefore, the frictional resistance generated between the contact portion 12D and the lower plate 15 when the upper plate 11 is moved relative to the lower plate 15 may be minimized.

A plurality of protrusion portions 13 may be formed on the upper plate 11. The plurality of protrusion portions 13 may protrude from the bottom surface of the upper plate 11 toward the lower plate 15.

The protrusion portion 13 may be spaced apart from the supporter 12 in the horizontal direction. The supporter 12 may be spaced apart from the lower plate 15 in the vertical direction. The protrusion portion 13 may move with the upper plate 11 and apply a force to the load cell 19.

The protrusion portion 13 may be coupled to the load cell 19. In more detail, the protrusion portion 13 may be provided with a coupling hole 14 to be coupled to the load cell 19. A coupling member such as a screw may be coupled to the load cell 19 by passing through the coupling hole 14.

The plurality of protrusion portions 13 may be spaced apart from each other. The number of protrusion portions 13 may be equal to the number of load cells 19. For example, the plurality of protrusion portions 13 may include a front protrusion portion 13A applying a force to a front load cell 19A, a rear protrusion portion 13B applying a force to a rear load cell 19B, a left protrusion portion 13C applying a force to a left load cell 19C, and a right protrusion portion 13D applying a force to a right load cell 19D.

The front protrusion portion 13A and the rear protrusion portion 13B may be disposed on a straight line in the front-and-rear direction. The left protrusion portion 13C and the right protrusion portion 13D may be disposed on a straight line in the right-and-left direction.

The front protrusion portion 13A and the rear protrusion portion 13B may apply a force to the load cell 19 in the front-and-rear direction. The left protrusion portion 13C and the right protrusion portion 13D may apply a force to the load cell 19 in the left-and-right direction.

Meanwhile, as described above, the lower plate 15 may include a bent portion 16 bent upward from both edges of the lower plate 15, and a protrusion portion 17 protruding upward from the front and rear edges of the lower plate 15.

The load cell 19 may be coupled to the bent portion 16 and the protrusion portion 17. The bent portion 16 and the protrusion portion 17 may be referred to as fixing portions 16 and 17. Coupling holes 18 to which the load cell 19 is coupled may be formed in the fixing portions 16 and 17. A coupling member such as a screw may be coupled to the load cell 19 by passing through the coupling hole.

The load cell 19 may be disposed between the upper plate 11 and the lower plate 15. The load cell 19 may be spaced apart from the upper plate 11 and the lower plate 15 in the vertical direction. The load cell 19 may detect a lateral force.

The load cell 19 may be disposed between the protrusion portions 13 protruding downward from the upper plate 11 and the fixing portions 16 and 17 bent or protruding upward from the lower plate 15. In more detail, the load cell 19 may be disposed between the protrusion portions 13 and the fixing portions 16 and 17 with respect to the horizontal direction. The outside of the load cell 19 may be coupled to the protrusion portion 13, and the inside of the load cell 19 may be coupled to the fixing portions 16 and 17.

When the upper plate 11 moves relative to the lower plate 15, the load cell 19 may be deformed between the protrusion portions 13 and the fixing portions 16 and 17. That is, the upper plate 11 may be movable within the deformation range of the load cell 19 with respect to the lower plate 15.

Therefore, as the external force applied to the upper plate 11 increases, the deformation of the load cell 19 may increase. In addition, the deformation direction and degree of each load cell 19 may be different according to the direction of the external force applied to the upper plate 11.

The load cell 19 may be provided as a plurality of load cells. The plurality of load cells 19 may include first load cells 19A and 19B configured to detect a force acting in the front-and-rear direction, and second load cells 19C and 19D configured to detect a force acting in the left-and-right direction.

The first load cells 19A and 19B may be disposed at the central portion of the lower plate 15 with respect to the left-and-right direction. The second load cells 19C and 19D may be disposed at the central portion of the lower plate 15 with respect to the front-and-rear direction.

The first load cells 19A and 19B may include a front load cell 19A adjacent to the front edge of the lower plate 15 and a rear load cell 19B adjacent to the rear edge of the lower plate 15.

The front load cell 19A may be coupled to the protrusion portion 17 adjacent to the front edge of the lower plate 15. The rear load cell 19B may be coupled to the protrusion portion 17 adjacent to the rear edge of the lower plate 15.

When the upper plate 11 moves forward with respect to the lower plate 15, the front protrusion portion 13A may push the front load cell 19A forward, and the rear protrusion portion 13B may pull the rear load cell 19B forward. Therefore, the front load cell 19A may be compressed in the front-and-rear direction, and the rear load cell 19B may be stretched in the front-and-rear direction.

When the upper plate 11 moves backward with respect to the lower plate 15, the front protrusion portion 13A may pull the front load cell 19A backward, and the rear protrusion portion 13B may push the rear load cell 19B backward. Therefore, the front load cell 19A may be stretched in the front-and-rear direction, and the rear load cell 19B may be compressed in the front-and-rear direction.

The second load cells 19C and 19D may include a left load cell 19C adjacent to the left edge of the lower plate 15, and a right load cell 19D adjacent to the right edge of the lower plate 15.

The left load cell 19C may be coupled to the bent portion 16 formed at the left edge of the lower plate 15. The right load cell 19D may be coupled to the bent portion 16 adjacent to the right edge of the lower plate 15.

When the upper plate 11 is rotated to the left relative to the lower plate 15, the left protrusion portion 13C may push the left load cell 19C in the left direction, and the right protrusion portion 13D may pull the right load cell 19D in the left direction. Therefore, the left load cell 19C may be compressed in the left-and-right direction, and the right load cell 19D may be stretched in the left-and-right direction.

When the upper plate 11 is rotated to the right relative to the lower plate 15, the left protrusion portion 13C may pull the left load cell 19C in the right direction, and the right protrusion portion 13D may push the right load cell 19D in the right direction. Therefore, the left load cell 19C may be stretched in the left-and-right direction, and the right load cell 19D may be compressed in the left-and-right direction.

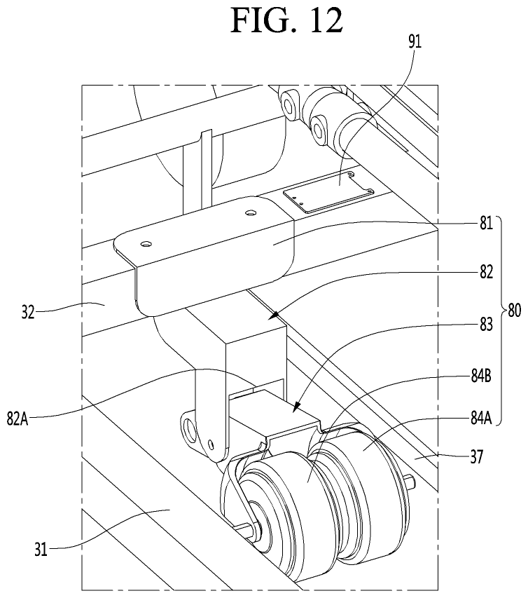

FIG. 12 is an enlarged view illustrating a driving wheel module and the surroundings thereof according to an embodiment.

As described above, the driving wheel module 80 may drive the moving bed robot or may assist the movement of the moving bed robot.

The driving wheel module 80 may include fixing brackets 81 and 82, moving brackets 83, and driving wheels 84A and 84B.

The fixing brackets 81 and 82 may be coupled and fixed to the base frame 30, more particularly, the connecting beam 32.

The fixing brackets 81 and 82 may include a coupling portion 81 coupled to the connecting beam 32, and a connecting portion 82 connected to the coupling portion 81 and rotatably connected to the moving bracket 83.

The coupling portion 81 may include an upper cover portion covering a part of the upper surface of the connecting beam 32, and a front cover portion bent downward from the upper cover portion to cover a part of the front surface of the connecting beam 32.

The connecting portion 82 may have an approximately “-1” shape. The bottom surface and back surface of the connecting portion 82 may be opened. In more detail, the connecting portion 82 may include an upper part connected to the coupling portion 81 and formed to extend in the front-and-rear direction, and a front part formed to extend downward from the front end of the upper part. The upper part may be connected to the coupling portion 81, more specifically, the front cover portion.

The fixing brackets 81 and 82 may be provided with openings 82A for preventing interference with the moving brackets 83. In more detail, the openings 82A may be formed in the connecting portion 82, and may be connected to the opened bottom surface of the connecting portion 82. In more detail, the opening 82A may be formed on the front surface of the front part, and may be connected to the opened bottom surface of the front part.

The moving bracket 83 may be rotatably connected to the fixing brackets 81 and 82, more specifically, the connecting portion 82.

The moving bracket 83 may rotate about a rotational axis extending in the left-and-right direction with respect to the fixing brackets 81 and 82. The moving bracket 83 may rotate in the vertical direction. A part of the moving bracket 83 may be disposed in the opening 82A.

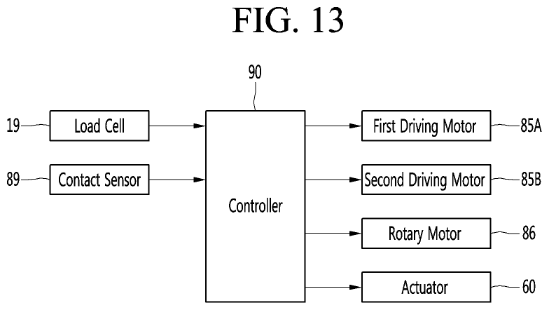

The driving wheel module 80 may further include a rotary motor 86 (see FIG. 13). The rotary motor 86 may rotate the moving bracket 83 in the vertical direction. The rotary motor 86 may be installed in the fixing brackets 81 and 82.

The rotary motor 86 may rotate the moving bracket 83 upward such that the driving wheels 84A and 84B are spaced apart from the floor surface, and may rotate the moving bracket 83 downward such that the driving wheels 84A and 84B are in contact with the floor surface.

The driving wheels 84A and 84B may be connected to the moving bracket 83. The driving wheels 84A and 84B may rotate about a rotational axis extending in the left-and-right direction with respect to the moving bracket 83.

The driving wheels 84A and 84B may be disposed in front of the fixing brackets 81 and 82.

The driving wheels 84A and 84B may be provided as a pair of driving wheels spaced apart in the left-and-right direction. The pair of driving wheels 84A and 84B may include a first driving wheel 84A and a second driving wheel 84B.

The rotational shaft of the first driving wheel 84A and the rotational shaft of the second driving wheel 84B may be disposed on a straight line. The first driving wheel 84A and the second driving wheel 84B may rotate independently of each other.

The driving wheel module 80 may further include driving motors 85A and 85B (see FIG. 13). The driving motors 85A and 85B may rotate the driving wheels 84A and 84B. The driving motors 85A and 85B may be installed in the moving bracket 83.

The driving motors 85A and 85B may be provided as a pair of driving motors and may rotate the pair of driving wheels 84A and 84B. In more detail, the pair of driving motors 85A and 85B may include a first driving motor 85A configured to rotate the first driving wheel 84A and a second driving motor configured to rotate the second driving wheel 84B.

When the moving bed robot moves straight, the driving motors 85A and 85B may rotate the pair of driving wheels 84A and 84B in the same direction. The driving motors 85A and 85B may rotate the pair of driving wheels 84A and 84B in opposite directions when the moving bed robot is turned.

The driving wheel module 80 may further include a contact sensor 89 (see FIG. 13). The contact sensor 89 may detect whether the driving wheels 84A and 84B are in contact with the floor surface. The type of the contact sensor 89 is not limited.

FIG. 13 is a control block diagram of the moving bed robot according to an embodiment.

The moving bed robot according to the present embodiment may further include a controller 90. The controller 90 may include at least one processor. The controller 90 may include a printed circuit board (PCB) 91 (see FIG. 12) disposed on the upper surface of the connecting beam 32.

For example, the at least one processor may include the processor 180 and the learning processor 130 of the AI device 100 shown in FIG. 1. Each of the at least one processor may be implemented as an integrated circuit, a microcomputer, a CPU, an application processor (AP), an application specific integrated circuit (ASIC), etc.

The controller 90 may control the rotary motor 86 to rotate the moving bracket 83 upward or downward. That is, the controller 90 may control the rotary motor 86 to bring the driving wheels 84A and 84B into contact with the floor surface or separate the driving wheels 84A and 84B from the floor surface.

The controller 90 may control the moving bed robot in one of a driving mode, an assist mode, or a caster mode.

The driving mode may refer to a mode in which the driving wheel module 80 is driven even if external force is not applied to the moving bed robot, such that the moving bed robot is autonomously driven. Accordingly, the driving mode is advantageous in that the moving bed robot may travel without applying external force by an operator.

The assist mode may refer to a mode in which the driving wheel module 80 assists movement of the moving bed robot by driving the driving wheel module 80 according to the magnitude and direction of external force applied to the upper plate 11 of the moving bed robot. Accordingly, the assist mode is advantageous in that the moving bed may easily move without using a large force by an operator.

The caster mode may refer to a mode in which the driving wheel module 80 does not intervene in movement of the moving bed robot. Accordingly, the caster mode is advantageous in that the movement direction of the moving bed robot is not limited to the directions of the driving wheels 84A and 84B. For example, in the caster mode, the operator may move the moving bed robot from side to side.

In the driving mode or the assist mode, the controller 90 may control the rotary motor 86 to rotate the moving bracket 83 downward and bring the driving wheels 84A and 84B into contact with the floor surface. Accordingly, the moving bed robot may move by rotation force of the driving wheels 84A and 84B.

In the caster mode, the controller 90 may control the rotary motor 86 to rotate the moving bracket 83 upward and separate the driving wheels 84A and 84B from the floor surface. Accordingly, the driving wheels 84A and 84B may not intervene in movement of the moving bed robot.

The controller 90 may electrically communicate with the contact sensor 89, and receive the result of detection of the contact sensor 89. Accordingly, the controller 90 may determine whether the driving wheels 84A and 84B are in contact with the floor surface.

In the driving mode or the assist mode, the controller 90 may communicate with the contact sensor 89 to control the rotary motor 86 such that the driving wheels 84A and 84B are kept in the contact with the floor surface. As a result, the moving bed robot may reliably travel or movement thereof may be assisted even when the floor surface is curved or uneven.

The controller 90 may receive an electrical signal from a load cell 19. Preferably, the controller 90 may receive the electrical signal from the load cell in the driving mode or the assist mode.

The controller 90 may calculate the magnitude and direction of external force applied to the upper plate 11 based on the signal of the load cell 19.

The controller 90 may control rotation of the driving motors 85A and 85B. More specifically, the controller 90 may receive the electrical signal of the load cell 19 and control rotation of the driving motors 85A and 85B.

The controller 90 may control the rotation speed of the driving motors 85A and 85B in proportion to the magnitude of the external force applied to the upper plate 11. That is, when the operator weakly pushes or pulls the upper plate 11, the controller 90 may slowly rotate the driving wheels 84A and 84B at a low speed, and, when the upper plate 11 is strongly pushed or pulled, the controller 90 may rapidly rotate the driving wheels 84A and 84B.

The controller 90 may control the rotation directions of the driving motors 85A and 85B according to the direction of the external force applied to the upper plate 11.

When the operator pushes or pulls the upper plate 11 forward and backward, the upper plate 11 may move forward and backward with respect to the lower plate 15 and the first load cells 19A and 19B may be deformed. More specifically, the first load cells 19A and 19B may be compressed or extended in the front-and-rear direction.

In this case, the controller 90 may control the driving motors 85A and 85B to rotate the driving wheels 84A and 84B such that the moving bed robot moves forward or backward. That is, the controller 90 may rotate the first driving wheel 84A and the second driving wheel 84B in the same direction.

The operator may push or pull the upper plate 11 to change the movement direction of the moving bed robot. That is, the operator may rotate the moving bed robot to the left or right, and the upper plate 11 may rotate while moving forward and backward with respect to the lower plate 15. According, the first load cells 19A and 19B and the second load cells 19C and 19D may be deformed. More specifically, the first load cells 19A and 19B may be compressed or extended in the front-and-rear direction, and the second load cells 19C and 19D may be compressed or extended in the left-and-right direction.

In this case, the controller 90 may control the driving motors 85A and 85B to rotate the driving wheels 84A and 84B such that the moving bed robot turns left or right. That is, the controller 90 may rotate the first driving wheel 84A and the second driving wheel 84B in opposite directions. Therefore, the rotation radius of the moving bed robot may be decreased, and easy direction change is possible.

Meanwhile, the controller 90 may control the actuator 60 to adjust the height of the moving bed robot. More specifically, the controller 90 may control the actuator 60 to push the connecting rod 65, thereby increasing the height of the connecting frame 40 and move upward the upper plate 11 and the lower plate 15. In contrast, the controller 90 may control the actuator 60 to pull the connecting rod 65 to decrease the height of the connecting frame 40 and move downward the upper plate 11 and the lower plate 15.

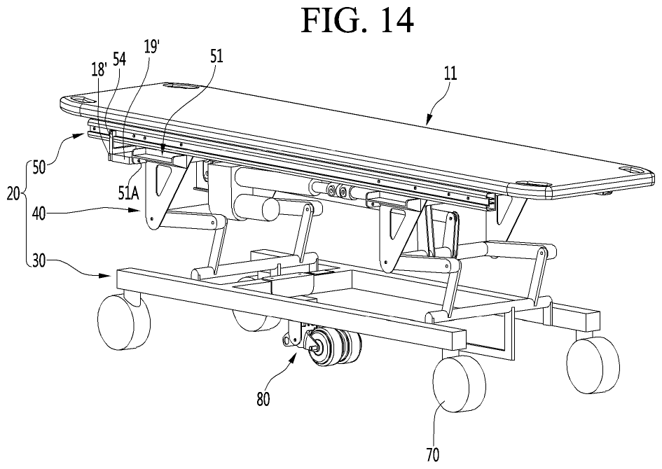

FIG. 14 is a perspective view of a moving bed robot according to another embodiment, and FIG. 15 is a cross-sectional view for describing a structure of a handle illustrated in FIG. 14.

Hereinafter, the contents overlapping with those described in the aforementioned embodiments will be omitted and the differences will be mainly described.

The moving bed robot according to the present embodiment may further include a handle 51, a rail 55, and a slider 52. The moving bed robot according to the present embodiment may not include the lower plate 15 described above.

The rail 55 may be provided with a support beam 50. More specifically, the rail 55 may be coupled to the inside of the support beam 50. The rail 55 may be formed to extend in the front-and-rear direction. The rail 55 may be disposed below the upper plate 11.

The slider 52 may slide along the rail 55. The rail 55 may be provided with a rail groove 55A into which the slider 52 is fitted, and the slider 52 may move forward and backward along the rail 55 in a state where a part thereof is fitted into the rail groove 55A. The slider 52 may be disposed below the upper plate 11.

The cross section of the slider 52 may be a “└” shape. More specifically, the slider 52 may include a first part formed to extend vertically and a second part bent to extend outward from a lower end of the first part. A protrusion portion fitted into the rail groove 55A may be formed at the upper end of the first part. The outer end of the second part may be connected to the handle 51.

The handle 51 may be connected to the slider 52. The handle 51 may move forward and backward together with the slider 52.

The handle 51 may be disposed below the support beam 50. The handle 51 may be spaced apart below the support beam 50. The handle 51 preferably protrudes outward from the support beam 50.

A fixing portion 18′ may be disposed below the support beam 50. The fixing portion 18′ may be connected to the support beam 50 by a connector 54, and may be spaced apart below the support beam 50. The fixing portion 18′ may face the handle 51 in the longitudinal direction of the rail 55, that is, in the front-and-rear direction.

The load cell 19′ according to the present embodiment may be disposed between the handle 51 and the fixing portion 18′. More specifically, the load cell 19′ may be disposed between the fixing portion 18′ and the handle 51 with respect to the longitudinal direction of the rail 55, that is, the front-and-rear direction.

The load cell 19′ may be coupled to the fixing portion 18′ and the handle 51. More specifically, one side of the load cell 19′ may be coupled to the fixing portion 18′ and the other side of the load cell 19′ may be coupled to the handle 51.

Hereinafter, a case in which the handle 51 is disposed in front of the fixing portion 18′ will be described as an example.

The operator may hold the handle 51 and apply a force forward or backward. When the operator moves the handle 51 forward, the handle 51 may pull the load cell 19′ forward, and the load cell 19′ may be extended. When the operator moves the handle 51 backward, the handle 51 may push the load cell 19′ backward, and the load cell 19′ may be compressed.

Therefore, the controller 90 may control the driving wheel module 80 according to the magnitude and direction of the external force applied to the handle 51.

As compared with the earlier described embodiment, the moving bed robot according to the present embodiment has a limitation that it can only support driving in the front-and-rear however; it has an advantage that the configuration is relatively simple and the manufacturing cost is low.

In the moving bed robot according to the above embodiments, the load cell may detect the force applied to the upper plate or the handle, and the driving wheel may rotate according to the electrical signal of the load cell to assist the movement of the moving bed robot. The operator may easily move the moving bed robot even with a small force.

In addition, if the operator only pushes or pulls the upper plate or the handle without a separate operation, the driving wheel may assist the driving of the moving bed robot accordingly. Therefore, there is an advantage that the operator can use the moving bed robot intuitively.

In addition, the upper plate may be supported relative to the lower plate by the supporter, and the lower plate may be coupled to the frame. Therefore, there is an advantage that the upper plate is movable relative to the lower plate in the horizontal omni-directions.

In addition, the contact portion that is included in the supporter and is in contact with the lower plate may have a smaller cross-sectional area toward the lower side. Hence, frictional resistance between the contact portion and the lower plate may be reduced.

In addition, the fixing portion of the lower plate may be spaced apart from the upper plate, and the protrusion portion of the upper plate may be spaced apart from the lower plate. Hence, friction generated when the upper plate moves relative to the lower plate may be minimized.

In addition, the first load cell may detect the force acting in the front-and- rear direction, and the second load cell may detect the force acting in the left-and-right direction. Therefore, by combining the deformation information of the first load cell and the second load cell, the direction of the external force applied to the upper plate may be detected for the horizontal omni-directions.

In addition, when the moving bed robot rotates left or right, the pair of driving wheels may rotate in opposite directions. Therefore, the rotation radius of the moving bed robot may be decreased, and easy direction change is possible.

In addition, the driving wheel may be connected to the moving bracket that rotates vertically with respect to the fixing bracket. Therefore, the driving wheel may be in contact with the floor surface or separated from the floor surface by the rotation of the moving bracket.

In addition, it is possible to determine whether the floor surface is in contact with the driving wheel by the sensor, and the rotary motor may control the moving bracket such that the driving wheel and the floor surface maintain the contact. This allows the moving bed robot to travel reliably or to be assisted in the movement even when the floor surface is curved or uneven.

In addition, the height of the connecting frame may be adjusted by the actuator and the connecting rod. Therefore, the height of the moving bed robot may be automatically adjusted.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to describe the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A moving bed robot comprising:
an upper plate;
a lower plate located below the upper plate;
a supporter extending downward from the upper plate, the supporter contacting the lower plate to support the upper plate;
a plurality of load cells located between the upper plate and the lower plate to detect a force applied to the upper plate;
a fixing portion extending upward from the lower plate and coupled to each load cell;
a protrusion portion extending downward from the upper plate and coupled to the each load cell opposite the fixing portion with respect to each load cell to apply a force to each load cell;
a frame connected to the lower plate and provided with a caster;
a driving wheel connected to the frame;
a driving motor configured to rotate the driving wheel; and
a controller configured to:
receive an electrical signal of each load cell; and
control the driving motor.

2. The moving bed robot according to claim 1, wherein the plurality of load cells includes:
a first load cell configured to detect a force acting in a front-and-rear direction of the upper plate; and
a second load cell configured to detect a force acting in a left-and-right direction of the upper plate.

3. The moving bed robot according to claim 2, wherein the first load cell is located at a central portion of the lower plate with respect to the left-and-right direction, and
the second load cell is located at a central portion of the lower plate with respect to the front-and-rear direction.

4. The moving bed robot according to claim 2, wherein the fixing portion is formed at an edge of the lower plate.

5. The moving bed robot according to claim 2, wherein the first load cell includes:
a front load cell adjacent to a front edge of the lower plate; and
a rear load cell adjacent to a rear edge of the lower plate, and
wherein the second load cell includes:
a left load cell adjacent to a left edge of the lower plate; and
a right load cell adjacent to a right edge of the lower plate.

6. The moving bed robot according to claim 1, wherein the supporter includes a contact portion contacting the lower plate, the contact portion having a smaller cross-sectional area than a portion of the supporter adjacent the upper plate.

7. The moving bed robot according to claim 1, wherein the fixing portion is spaced apart from the upper plate in a vertical direction, and
wherein the protrusion portion is spaced apart from the lower plate in the vertical direction.

8. The moving bed robot according to claim 1, wherein the driving wheel is provided as a pair of driving wheels having aligned rotational shafts, and
wherein the driving motor is provided as a pair of driving motors configured to independently rotate the pair of driving wheels.

9. The moving bed robot according to claim 1, further comprising:
a fixing bracket fixed to the frame;
a moving bracket connected to the fixing bracket and the driving wheel; and
a rotary motor configured to rotate the moving bracket with respect to the fixing bracket.

10. The moving bed robot according to claim 9, further comprising a contact sensor configured to detect whether the driving wheel contacts a floor surface on which the moving bed robot is located.

11. The moving bed robot according to claim 10, wherein the controller is configured to:
electrically communicate with the contact sensor to control the rotary motor such that the driving wheel maintains contact with the floor surface; or
control the rotary motor such that the driving wheel is separated from the floor surface.

12. The moving bed robot according to claim 1, wherein the upper plate is movable with respect to the lower plate within a deformation range of each load cell.

13. The moving bed robot according to claim 1, wherein the frame includes:
a base frame provided with the caster and the driving wheel;
a pair of support beams coupled to opposite sides of the lower plate, the pair of support beams extending in a front-and-rear direction of the upper plate; and
a connecting frame configured to connect the pair of support beams to the base frame.

14. The moving bed robot according to claim 13, wherein the caster is provided as a plurality of casters, and
wherein the base frame includes:
a pair of base beams extending in the front-and-rear direction of the upper frame, the pair of base beams connected to the plurality of casters, and the pair of base beams being spaced apart in parallel in a left-and-right direction of the upper frame; and
a connecting beam extending in the left-and-right direction of the upper frame to connect the pair of base beams, the connecting beam being connected to the driving wheel.

15. The moving bed robot according to claim 14, wherein the base frame further includes:
a front base bar connecting the pair of base beams, the front base bar being forward of the connecting beam;
a rear base bar connecting the pair of base beams, the rear base bar being rearward of the connecting beam;
a pair of front supports provided so as to be inclined vertically or upwardly from the front base bar; and
a pair of rear supports provided so as to be inclined vertically or upwardly from the rear base bar.

16. The moving bed robot according to claim 15, wherein the connecting frame includes:
a pair of front frames coupled to front portions of the pair of support beams, respectively;
a pair of rear frames coupled to rear portions of the pair of support beams, respectively;
a front connecting bar extending in the left-and-right direction of the upper plate to connect the pair of front frames, the front connecting bar being located below the lower plate;
a rear connecting bar extending in the left-and-right direction of the upper plate to connect the pair of rear frames, the rear connecting bar located below the lower plate;
a pair of front links rotatably connecting the pair of front supports and the pair of front frames; and
a pair of rear links rotatably connecting the pair of rear supports and the pair of rear frames.

17. The moving bed robot according to claim 16, wherein the connecting frame further includes:
a front link bar connecting the pair of front links; and
a rear link bar connecting the pair of rear links.

18. The moving bed robot according to claim 17, further comprising an actuator connecting the rear connecting bar to the front link bar.

19. The moving bed robot according to claim 18, wherein the front link bar includes a lever, and
wherein the actuator includes:
a cylinder connected to the rear connecting bar;
a piston moveable relative to the cylinder in the front-and-rear direction;
a connecting rod connected to the piston to move in the front-and-rear direction, the connecting rod being rotatably connected to the lever of the front link bar.

20. A moving bed robot comprising:
an upper plate;
a support beam located below the upper plate, the support beam including a rail extending in a longitudinal direction of the support beam;
a slider configured to slide along the rail;
a handle connected to the slider to slide together with the slider;
a fixing portion connected to a lower side of the support beam and facing the handle in the longitudinal direction of the support beam;
a load cell located between the fixing portion and the handle;
a base frame provided with a caster;
a connecting frame connecting the support beam to the base frame;
a driving wheel connected to the base frame;
a driving motor configured to rotate the driving wheel; and
a controller configured to:
receive an electrical signal of the load cell; and
control the driving motor.
